(19) United States
(12) Patent Application Publication
(10) Pub. No.: US 2020/0311893 A1
(43) Pub. Date: Oct. 1, 2020

(54) IMAGE PROCESSING APPARATUS WITH IMAGES HAVING DIFFERENT IN-FOCUS POSITIONS, IMAGE PICKUP APPARATUS, IMAGE PROCESSING METHOD, AND COMPUTER READABLE STORAGE MEDIUM

(71) Applicant: CANON KABUSHIKI KAISHA, Tokyo (JP)

(72) Inventor: Masashi Jobara, Kawasaki-shi (JP)

(21) Appl. No.: 16/824,534

(22) Filed: Mar. 19, 2020

(30) Foreign Application Priority Data
Mar. 26, 2019 (JP) 2019-059213

(51) Int. Cl. G06T 5/50; G06T 1/60; G06T 1/20; G06T 7/50

(52) U.S. Cl. CPC G06T 5/50; G06T 7/50; G06T 1/20; G06T 1/60

(57) ABSTRACT

An image processing apparatus includes at least one memory configured to store instructions, and at least one processor in communication with the at least one memory and configured to execute the instructions to calculate coefficients of alignment for a plurality of images having different in-focus positions and field angles at least partially overlapping with each other, execute image processing on the plurality of images, and combine the plurality of images that has undergone the image processing to generate a composite image using the coefficients of alignment. A depth of field of the composite image is deeper than depths of field of the plurality of images.

### BACKGROUND

### Field

One disclosed aspect of the embodiments relates to an image processing apparatus that aligns a plurality of images.

### Description of the Related Art

A plurality of objects which are separated at much different distances from an image processing apparatus such as a digital camera, or a long object having great depth may be imaged. In this case, only some objects are brought into focus or the object is partially brought into focus in some cases because of insufficient depth of field. In order to solve such a problem, Japanese Patent Application Laid-Open No. 10-290389 discusses a so-called depth combining technique. With this technique, a plurality of images having different in-focus positions are picked up to extract only in-focus areas from the respective images and combine them into one image, so that a composite image is generated where an entire image pickup area is brought into focus.

The depth combining method discussed in Japanese Patent Application Laid-Open No. 10-290389 includes the following method. First, general image processing such as brightness correction processing such as white balance, and sharpness adjustment processing is executed on the picked-up images. Then, processing for combining the depth is executed. Image alignment may be desirable in the depth combining processing. In order to achieve the alignment, a method for calculating coefficients of alignment based on images to be subjected to the alignment is used.

However, when the coefficients of alignment are calculated using images which have undergone the image processing, calculation of the coefficients of alignment might not be accurately carried out under the undesirable effects of the image processing.

### SUMMARY

According to an aspect of the embodiments, an image processing apparatus includes a memory and a processor in communication with the memory. The processor calculates coefficients of alignment for a plurality of images having different in-focus positions, and field angles at least partially overlapping with each other. The processor executes image processing on the plurality of images. The processor combines the plurality of images which has undergone the image processing to generate a composite image using the coefficients of alignment. A depth of field of the composite image is deeper than depths of field of the plurality of images.

Further features of the disclosure will become apparent from the following description of exemplary embodiments with reference to the attached drawings.

### BRIEF DESCRIPTION OF THE DRAWINGS

FIG. 1 is a block diagram illustrating a hardware configuration of a digital camera according to a first exemplary embodiment.

FIG. 2 is a flowchart describing image combining processing according to the first exemplary embodiment.

FIG. 3 is a flowchart describing calculation of coefficients of alignment according to the first exemplary embodiment.

FIG. 4 is a diagram describing sharpness processing according to the first exemplary embodiment.

FIG. 5 is a flowchart describing depth combining according to the first exemplary embodiment.

FIG. 6 is a flowchart describing image combining processing according to a second exemplary embodiment.

FIG. 7 is a flowchart describing depth combining according to the second exemplary embodiment.

### DESCRIPTION OF THE EMBODIMENTS

Suitable exemplary embodiments of the disclosure will be described in detail below with reference to the accompanying drawings.

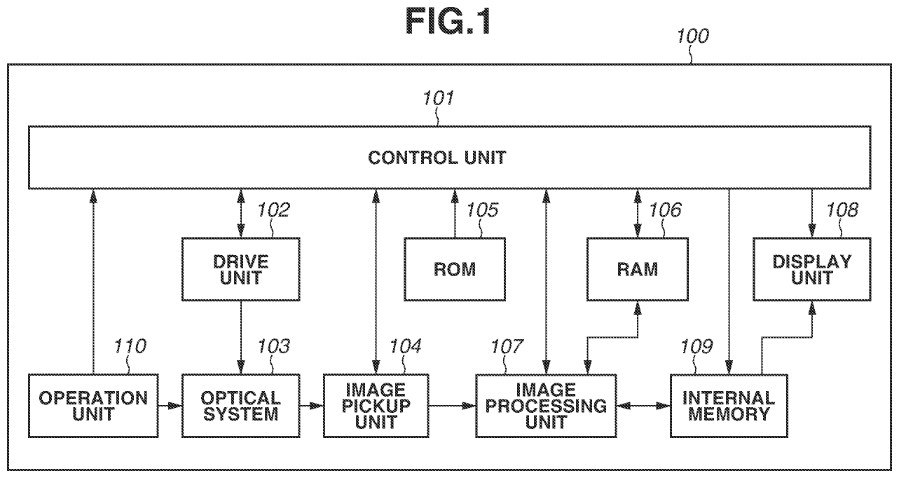

A first exemplary embodiment will be described below. FIG. 1 is a block diagram illustrating a hardware configuration of a digital camera according to the present exemplary embodiment. A digital camera 100 can pick up a still image, can record information about an in-focus position, and can calculate a contrast value and combine the images. Further, the digital camera 100 can execute enlargement or reduction processing on the picked up and saved images, or an image externally input.

A control unit 101, which is a signal processor such as a central processing unit (CPU) or a micro-processing unit (MPU), controls respective units of the digital camera 100 while reading out programs stored in advance in a read only memory (ROM) 105, and performs operations as described below. For example, as described below, the control unit 101 issues a command relating to start and end of image pickup to an image pickup unit 104, described below. Alternatively, the control unit 101 issues a command relating to the image processing to an image processing unit 107, described below, based on the program contained in the ROM 105. A command from a user is input into the digital camera 100 by an operation unit 110, described below, and reaches respective units of the digital camera 100 via the control unit 101.

A drive unit 102, which is configured by a motor or the like, mechanically operates an optical system 103, described below, under a command of the control unit 101. For example, the drive unit 102 moves a position of a focus lens included in the optical system 103 based on the command of the control unit 101 to adjust a focal length of the optical system 103.

The optical system 103 includes a zoom lens, a focus lens, and an aperture. The aperture is a mechanism that adjusts a quantity of light to be transmitted. Shift of the lens position can change an in-focus position.

The image pickup unit 104, which is a photoelectric conversion device, photoelectrically converts an incident optical signal into an electrical signal. For example, a charge-couple device (CCD) sensor or a complementary metal oxide semiconductor (CMOS) sensor is applicable to the image pickup unit 104. The image pickup unit 104, which has a moving image pickup mode, can pick up a plurality of temporally continuous images as frames of a moving image, respectively.

The ROM 105, which is a read only nonvolatile memory as a recording medium, stores operation programs for each block of the digital camera 100, and parameters required in operations of the blocks. The RAM 106, which is an erasable volatile memory, is used as a temporary storage area for data output in the operations of the blocks of the digital camera 100.

The image processing unit 107 executes various image processing on images output from the image pickup unit 104 or data of an image signal recorded in an internal memory 109, described below. The image processing includes white balance adjustment processing, color interpolation processing, and filtering processing. Further, the image processing unit 107 executes compression processing according to the standard of Joint Photographic Experts Group (JPEG) or the like on the data of the image signal picked up by the image pickup unit 104.

The image processing unit 107 is configured by an application-specific integrated circuit (ASIC) including circuits that execute specific processing. Alternatively, the control unit 101 may achieve some or all of functions of the image processing unit 107 in a manner that the control unit 101 executes the processing based on the programs read out from the ROM 105. In a case where the control unit 101 achieves all the functions of the image processing unit 107, the image processing unit 107 as hardware may be omitted.

A display unit 108 is a liquid crystal display or an organic electroluminescent (EL) display that displays an image temporarily saved in the RAM 106, an image saved in the internal memory 109, described below, or a setting screen of the digital camera 100.

The internal memory 109 is a place where an image picked up by the image pickup unit 104, an image acquired by the processing executed by the image processing unit 107, and information about an in-focus position at the time of image pickup are recorded. Instead of the internal memory 109, a memory card may be used.

The operation unit 110 includes buttons or switches, keys, and mode dials provided in the digital camera 100, or a touch panel serving also as the display unit 108. A command from a user reaches the control unit 101 via the operation unit 110.

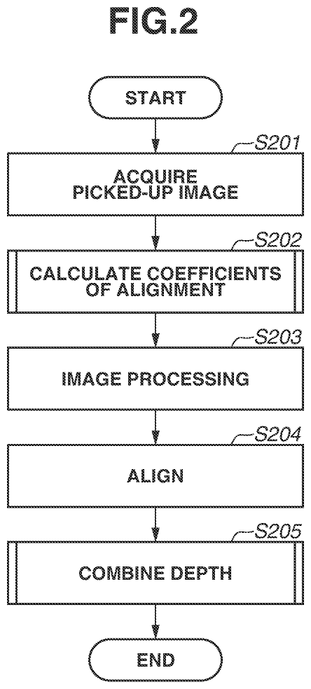

FIG. 2 is a flowchart describing image combining processing according to the present exemplary embodiment.

In step S201, the image pickup unit 104 picks up images of an object through the optical system 103, and saves in-focus positions at a time of the image pickup as well as the images picked up by the control unit 101 in the internal memory 109 or an external recording device. The in-focus position in an optical axis direction may be automatically or manually changed by a user under control of the control unit 101. In the present exemplary embodiment, the drive unit 102 drives the lens disposed in the optical system 103 to change the in-focus position, but the change of the in-focus position is not limited to this manner For example, a plurality of digital cameras may be used to pick up images in an in-focus state in different positions. However, in a case where the plurality of digital cameras is used, some measures are required to move optical axes of the digital cameras to be close to each other so that parallaxes among the images acquired by the plurality of digital cameras do not become great.

In step S202, the image processing unit 107 calculates coefficients of alignment for alignment target images, namely, the images picked up in step S201. Alignment refers to a process to adjust positions of an object in a plurality of images to be identical in the occasion when the objects of the plurality of images need to be at the same position. Even in a case where images are picked up while the in-focus position is being changed, there is a possibility that a position of the object varies in the picked-up images in hand-hold image pickup or even in image pickup using tripods on which the digital cameras are seated. Also, there is a possibility that an optical phenomenon occurs and the position of the object varies. If an identical object is in different positions, a desired result cannot be acquired in the combining processing at a subsequent stage. Thus, the object of the images is desirably moved, enlarged, reduced, or rotated to be aligned in advance so that the object is in identical positions on the images.

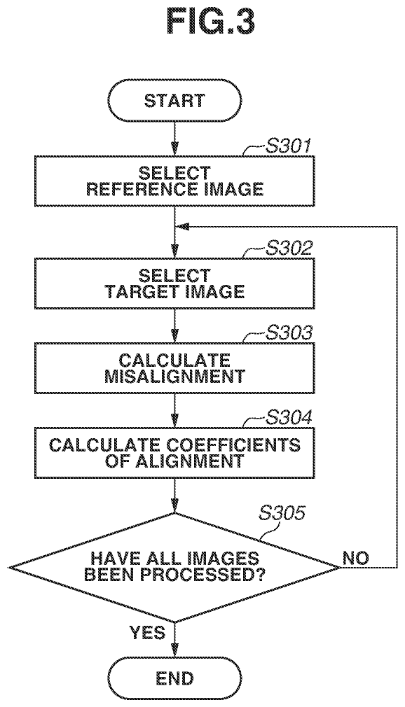

Details of the processing in step S202 will be described below in FIG. 3.

In step S203, the image processing unit 107 executes the image processing. The image processing in step S203 means mainly image processing for brightness and sharpness. Such processing includes image processing for uniformly changing brightness on entire images and sharpness processing for improving resolution of entire images.

Details of the processing in step S203 will be described below.

In step S204, the image processing unit 107 carries out alignment on the images that have undergone the image processing in step S203. Details of the processing in step S204 will be described below.

In step S205, the image processing unit 107 executes depth combining processing on the aligned images. In the present exemplary embodiment, the image processing unit 107 extracts portions having the highest contrast values from identical positions of the aligned images to generate a composite image. Details of the processing in step S205 will be described below.

FIG. 3 is a flowchart describing step S202 which calculates the coefficients of alignment according to the present exemplary embodiment.

In step S303, the image processing unit 107 calculates an amount of misalignment between a reference image and a processing image. One example of a calculation method will be described below. First, the image processing unit 107 sets a plurality of blocks on either one of the images. It is preferable that the image processing unit 107 sets the blocks such that the blocks have an identical size. The image processing unit 107, then, sets search ranges, which are wider than the set blocks in the same positions as the set blocks, on the other image. Lastly, the image processing unit 107 calculates corresponding points in the search ranges of the other image. The corresponding points are positioned where a sum of absolute difference (SAD) in brightness between the corresponding points and the blocks first set on the one image becomes minimum. The image processing unit 107 calculates misalignment as vectors from the centers of the blocks first set on the one image and the corresponding points. The image processing unit 107 may use a sum of squared difference (SSD) or a normalized cross correlation (NCC) other than the SAD, to calculate the corresponding points.

In step S304, the image processing unit 107 calculates coefficients of alignment based on the amount of misalignment calculated in step S303. The coefficients of alignment include, for example, coefficients of projective transformation. However, the coefficients of alignment are not limited only to the coefficients of projective transformation, and coefficients of affine transformation or simplified coefficients of horizontal or vertical shift may also be used.

For example, the image processing unit 107 can perform deformation using Equation (1).

$${I}^{′} = ( \begin{matrix}{x}^{′} \\ {y}^{′} \\ 1\end{matrix} ) = AI = ( \begin{matrix}a & b & c \\ d & e & f \\ g & h & i\end{matrix} ) ( \begin{matrix}x \\ y \\ 1\end{matrix} ) \qquad ( 1 )$$

In Equation (1), (x′, y′) represents coordinates after the alignment is carried out, and (x, y) represents coordinates before the alignment is carried out. A matrix A represents the coefficients calculated in step S304.

In step S305, the control unit 101 determines whether the alignment processing has been executed on all the images. If the alignment processing has been executed on all the images (Yes in step S305), the processing ends. If not (No in step S305), the processing returns to step S302, and a target image is selected from the unprocessed images.

The image processing according to the present exemplary embodiment will be described in detail below. For example, in a case where the image processing here is brightness correction processing and sharpness processing, the control unit 101 sets whether to execute the brightness correction processing and the sharpness processing on the images.

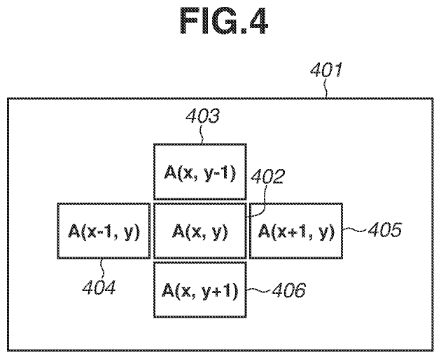

FIG. 4 is a diagram describing the sharpness processing according to the present exemplary embodiment.

FIG. 4 illustrates pixels 403 to 406 above, below, and on the right and left sides of any pixel 402 on an image 401. The image processing unit 107 can use a sharpening filter indicated in Equation (2) for the pixel 402.

A′(x,y)=5·A(x,y)−{A(x−1,y)+A(x+1,y)+A(x,y−1)+A(x,y1)}. (2)

A′ (x, y) represents values of the coordinates (x, y) after the filtering.

The application of the above-described sharpening filter can improve resolution of the images. In the actual image processing, different sharpening filters are prepared according to each edge intensity, and the control unit 101 selectively uses the sharpness filter based on situations. Any other methods such as sharpening processing using a reduced image called an unsharp mask can be used as long as the such methods achieve sharpening.

The alignment in step S204 will be described in detail. The image processing unit 107 selects a reference image from the images, which have undergone the image processing in step S203, and aligns the other processed images with the reference image. It is preferable that an image with the widest field angle is selected as the reference image. If the reference image is not the image with the widest field angle, a portion of a field angle that is not included in the reference image may be desirably deleted when an image having a wider field angle than the field angle of the reference image is aligned.

The depth combining processing in step S205 will be described. Information about contrast values desirable in the depth combining processing according to the present exemplary embodiment is generated by using an edge map.

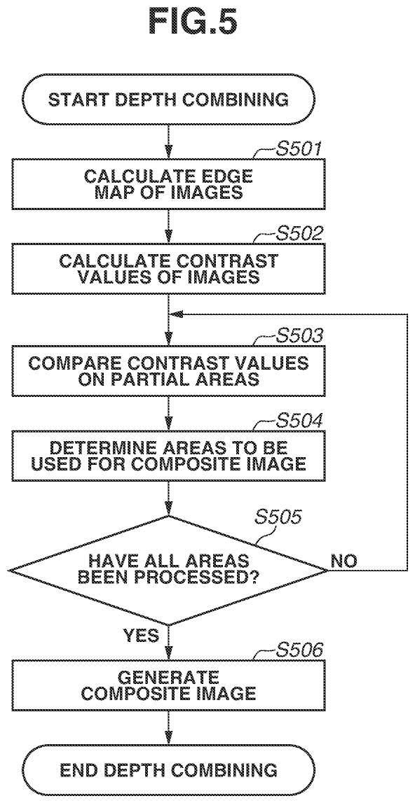

FIG. 5 is a flowchart describing the depth combining according to the present exemplary embodiment.

A′(x,y)={4·A(x,y)+A(x−1,y)+A(x+1,y)+A(x,y−1)+A(x,y+1)}/8. (3)

In Equation (3), A′ (x, y) represents values of the coordinates (x, y) in the generated edge map.

In step S502, the image processing unit 107 calculates contrast values of the images based on the edge map calculated in step S501. There exist some methods for obtaining the contrast values based on the edge map. In a present case, a method for comparing a sum total of values of target partial areas in the edge map is used. The partial areas herein mean areas on images including a plurality of pixels. For convenience of the processing, the partial areas preferably have rectangular shapes.

In step S503, the image processing unit 107 compares partial areas in the same positions with respect to the images on which the calculation in step S502 has been carried out.

In step S504, the image processing unit 107 determines that partial areas having the highest contrast values obtained by the comparison in step S503 are used for a composite image.

In step S505, the control unit 101 determines whether all the areas on the images have been processed. If all the areas have been processed (Yes in step S505), the processing proceeds to step S506. If areas which have not been processed remain (No in step S505), the processing returns to step S503.

In step S506, the image processing unit 107 replaces the areas determined to be used for a composite image in step S504 with a corresponding position of the composite image to generate the composite image. Further, it is preferable that smoothing processing is appropriately executed in the replacement so that boundary portions change smoothly.

In the processing in step S205, there can be another method for calculating contrast values. For example, the image processing unit 107 calculates brightness Y based on color signals Sr, Sg, and Sb of respective pixels using the following Equation (4).

Y=0.299Sr+0.587Sg+0.114Sb. (4)

The image processing unit 107 then calculates a contrast value I using a Sobel filter for a matrix L of the brightness Y of the pixels of 3×3 as indicated in the following Equations (5)-(7).

$$\begin{matrix}{I}_{h} = ( \begin{matrix}- 1 & 0 & 1 \\ - 2 & 0 & 2 \\ - 1 & 0 & 1\end{matrix} ) \cdot L . & ( 5 ) \\ {I}_{v} = ( \begin{matrix}- 1 & - 2 & - 1 \\ 0 & 0 & 0 \\ 1 & 2 & 1\end{matrix} ) \cdot L . & ( 6 ) \\ I = \sqrt{{I}_{h}^{2} + {I}_{v}^{2}} . & ( 7 )\end{matrix}$$

According to the first exemplary embodiment, before the image processing in step S203 is executed, the coefficients of alignment are calculated. In conventional depth combining, the calculation of the coefficients of alignment is made after the image processing, which causes the following problem. For example, in a case where the image processing such as the sharpness processing is executed, an edge, such as spurious resolution, that is not present on an original object is occasionally detected due to a parameter or an algorithm to be applied. Further, an edge, such as a noise that is not an object, occasionally becomes a main component of the edge map due to the sharpness processing that emphasizes high frequency. The calculation of the coefficients of alignment in such a case causes a great difference due to an undesirable effect due to a spurious resolution in the process of searching for corresponding points. Thus, other points may be recognized as the corresponding points.

In the present exemplary embodiment, the calculation of the coefficients of alignment before the image processing may improve the accuracy of the alignment in the image processing.

A second exemplary embodiment will be described below. In the first exemplary embodiment, the processing for generating a composite image including the calculation of the contrast values is executed after the image processing. In some cases, the image processing might cause undesirable effects in the accuracy in the calculation of the contrast values. For example, in a case where sharpness is extremely enhanced with respect to only specific images in a plurality of images, blurring areas that are out of in-focus are also emphasized. Thus, the contrast values of the images having enhanced blurring might be determined to be higher than the contrast values of the in-focused images. Originally, in a case where the sharpness of the specific images is adjusted and the depth combining is performed, it is desired that the resolution of the in-focus area is improved. Thus, it is not desired that an image where the sharpness is enhanced on foreground and background blurring images is obtained as a composite result. In the present exemplary embodiment, such a situation is assumed, and the alignment is carried out on both images before and after the image processing.

The second exemplary embodiment will be described in detail below with reference to the drawings. Description of portions similar to those in the first exemplary embodiment is omitted.

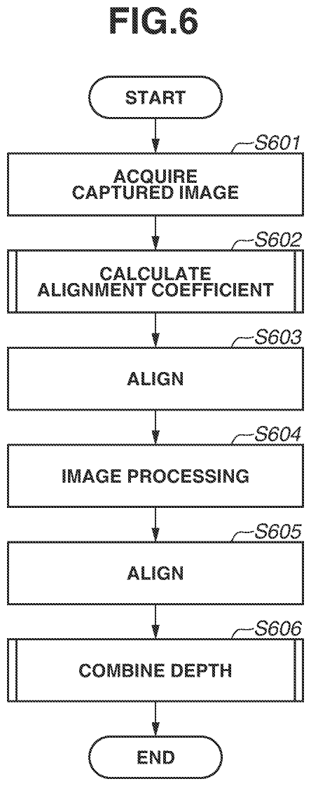

FIG. 6 is a flowchart describing the image combining processing according to the present exemplary embodiment.

The processing in step S601 is similar to the processing in step S201 according to the first exemplary embodiment.

The processing in step S602 is similar to the processing in step S202 according to the first exemplary embodiment.

In step S603, the image processing unit 107 carries out alignment on images before the image processing performed in step S604, described below. The images where the alignment has been carried out before the image processing are referred to as detection images. The detection images are used for selecting partial areas to be used for a composite image.

The processing in step S604 is similar to the processing in step S203 according to the first exemplary embodiment.

In step S605, the image processing unit 107 carries out alignment on the images which have undergone the image processing in step S604. The images which have undergone the alignment after the image processing are referred to as material images herein. The material images are images which are replaced actually with a composite image.

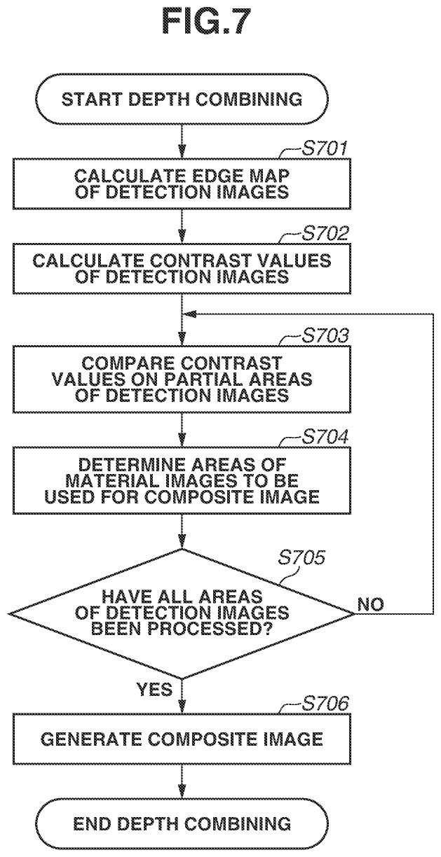

In step S606, the image processing unit 107 executes the depth combining processing. FIG. 7 is a flowchart describing the depth combining processing according to the present exemplary embodiment. Processing in step S606 will be described in detail below.

In step S701, the image processing unit 107 calculates an edge map of the detection images. The specific calculation method may be similar to the method according to the first exemplary embodiment.

In step S702, the image processing unit 107 calculates contrast values for the detection images. The specific calculation method may be similar to the method according to the first exemplary embodiment.

In step S703, the control unit 101 compares the contrast values of partial areas in the same positions of the detection images, and specifies an image having a partial area with the highest contrast value.

In step S704, the control unit 101 determines areas of the material images corresponding to the partial area specified in step S703. The determined areas of the material images are used for generating a composite image.

In step S705, the control unit 101 determines whether all the areas of the images have been processed. If all the areas have been processed (Yes in step S705), the processing proceeds to step S706, but if not (No in step S705), the processing returns to step S703.

In step S706, the image processing unit 107 generates a composite image using the areas of the material images determined in step S704.

According to the second exemplary embodiment, the partial areas are selected by using the images before the image processing, so that undesirable effects of the image processing on the accuracy in the calculation of the contrast values can be reduced.

The processing including the image pickup through the combining is executed in one device in the above-described exemplary embodiments, but the execution method is not limited to this. For example, the processing in step S201 in the flowchart of FIG. 2 is executed by one image pickup device, and the processing in and after step S202 may be executed by using another image processing apparatus such as a personal computer (PC) or a server. In such a configuration, at the time of the image pickup in step S201, information about the in-focus positions as well as the picked-up images needs to be saved. After the image pick-up, the information about the in-focus positions as well as the images from the image pickup device are transmitted to the image processing apparatus after the image pickup.

### Other Embodiments

The above exemplary embodiments have described the digital camera, but the disclosure is not limited to the digital camera. For example, the disclosure may be carried out using a mobile device containing an image pickup element, or a network camera that can pick up images.

The present disclosure can be achieved by supplying programs that achieve one or more functions in the above exemplary embodiments to a system or an apparatus via a network or a storage medium, and reading out the programs to execute the programs using one or more processors in a computer of the system or the apparatus. Further, the present disclosure can be achieved also by a circuit that realizes one or more functions (for example, ASIC).

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2019-059213, filed Mar. 26, 2019, which is hereby incorporated by reference herein in its entirety.

What is claimed is:

1. An image processing apparatus, comprising:
at least one memory configured to store instructions; and
at least one processor in communication with the at least one memory and configured to execute the instructions to:
calculate coefficients of alignment for a plurality of images having different in-focus positions, and field angles at least partially overlapping with each other;
execute image processing on the plurality of images; and
combine the plurality of images which has been undergone by the image processing to generate a composite image using the coefficients of alignment,
wherein a depth of field of the composite image is deeper than depths of field of the plurality of images.

2. The image processing apparatus according to claim 1, wherein the image processing includes at least one of brightness correction processing and sharpness processing.

3. The image processing apparatus according to claim 1, wherein the at least one processor further executes an instruction to extract in-focus areas of the plurality of images which has been undergone by the image processing to generate the composite image.

4. The image processing apparatus according to claim 3, wherein the at least one processor further executes an instruction to determine areas having highest contrast values among the areas in the same positions of the plurality of images which has been undergone by the image processing, as the in-focus areas.

5. The image processing apparatus according to claim 3, wherein the at least one processor further executes an instruction to determine areas of the plurality of images which has been undergone by the image processing corresponding to the areas having the highest contrast values among areas in the same positions of the plurality of images before the image processing, as the in-focus areas.

6. The image processing apparatus according to claim 1, wherein the plurality of images is different in the in-focus positions along an optical axis direction.

7. The image processing apparatus according to claim 1, wherein the coefficients of alignment are coefficients of projective transformation.

8. The image processing apparatus according to claim 1, wherein the at least one processor further executes an instruction to align the plurality of images which has been undergone by the image processing and then to combine the plurality of images using the coefficients of alignment.

9. An image pickup apparatus comprising:
an image sensor configured to pick up a plurality of images having different in-focus positions and field angles at least partially overlapping with each other;
at least one memory configured to store instructions; and
at least one processor in communication with the at least one memory and configured to execute the instructions to:
calculate coefficients of alignment for the plurality of images;
execute image processing on the plurality of images; and
combine the plurality of images which has been undergone by the image processing to generate a composite image using the coefficients of alignment,
wherein a depth of field of the composite image is deeper than depths of field of the plurality of images.

10. An image processing method comprising:
calculating coefficients of alignment for a plurality of images having different in-focus positions and field angles at least partially overlapping with each other;
executing image processing on the plurality of images; and
combining the plurality of images that has been undergone by the image processing to generate a composite image using the coefficients of alignment;
wherein a depth of field of the composite image is deeper than depths of field of the plurality of images.

11. A non-transitory computer-readable storage medium which stores a program for causing a computer of an image pickup apparatus to execute the image processing method according to claim 10.
